(19) United States
(12) Patent Application Publication
(10) Pub. No.: US 2002/0087295 A1
(43) Pub. Date: Jul. 4, 2002

(54) System and method for designing a digital television network

(75) Inventor: Jin Man Kim, Gyunggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/025,546

(22) Filed: Dec. 26, 2001

(30) Foreign Application Priority Data
Dec. 28, 2000 (KR) 83526/2000

(51) Int. Cl. G06F 17/10

(52) U.S. Cl. 703/2

(57) ABSTRACT

The present invention discloses a system and method for designing a digital television network by utilizing a wireless network design program and applying information from an existing analog television transmitting station. The system and method determine an optimum power for a digital television transmitting station by conducting a regression analysis. The system and method also calculate a coverage zone of a digital television using the optimum power for the digital television transmitting station and corresponding parameters thereof. Advantageously, the disclosed system and method maintain the network figure and the coverage zone of the existing analog television. Thus, influences and interferences with other networks are minimized.

### BACKGROUND OF THE INVENTION

1. Field of the Invention

The present invention relates to a digital television network design. In particular, the present invention relates to a system and method for designing a digital television network based on an existing analog television network.

2. Background of the Related Art

FIG. 1 is a flow chart describing a first related-art method for designing a digital television network. With reference to FIG. 1, in the prior art method, a link budget analysis is conducted for a digital television transmitting station (S1). Here, the link budget analysis determines a coverage zone of the digital television transmitting station broadcasting to a type of receiver. In general, link budget analysis is a technique used to examine or evaluate the gains and losses in a wireless telecommunication system. Also, the link budget calculation determines the minimum required transmission power of the television transmitting station.

In accordance with the result obtained by the link budget analysis, at least one parameter of the digital television transmitting station is determined (S2). The parameter may be the gain of the digital television transmitting station antenna, for example. The minimum required transmission power of a digital television transmitting station is calculated through the link budget, and the parameters used for calculating the minimum required transmission power are designated as the parameters of the digital television transmitting station.

On the basis of the parameters of the digital television transmitting station, a radio analysis is conducted to predict the coverage zone of the digital television transmitting station (S3). A digitalized map can be useful for the radio analysis.

Later, it is determined whether the actual coverage zone of the digital television transmitting station satisfies the predicted coverage zone (S4). If the actual coverage zone of the digital television transmitting station does not satisfy the pre-predicted coverage zone, then steps S2 and S3 described above are repeated until the actual coverage zone of the digital television transmitting station satisfies the predicted coverage zone. The design process is ended when the coverage zone of the digital television station satisfies the predicted coverage zone.

The related art method for designing digital television networks has many problems. For example, the related art method does not utilize information related to an existing analog television service in designing a new digital television service. As a result, the related art method is not reliable in designing new digital television transmitting stations that can cover regions currently served by analog television transmitters.

Many attempts have been made to overcome the above-described problems. A second related art method for designing a digital television network uses the existing analog television network information. Unfortunately, the second related art method requires an additional graphical radio model and a qualification procedure. Moreover, the network design process must be performed on each transmitting station to determine the network environment. Hence, the second related art method is more complex and consumes a great amount of time.

### SUMMARY OF THE INVENTION

An object of the invention is to solve at least the above problems and/or disadvantages and to provide at least the advantages described hereinafter.

Another object of the present invention to provide a system and method for designing a digital television network using analog television network information.

Another object of the present invention is to improve the performance of designed digital television networks.

Another object of the present invention is to decrease the amount of time required to design digital television networks.

In order to achieve at least the above objects in whole or in part, and in accordance with the purposes of the invention, as embodied and broadly described, there is provided a method for designing a digital television network that includes correcting a radio predictive model based on information related to an existing analog television transmitting station. Then, a link budget analysis is conducted based on parameters regarding the existing analog television transmitting station to calculate an estimated minimum required transmitting power needed to transmit the digital signal to all portions of the desired coverage area. A regression analysis is ten performed based on a digital television transmitting station design. The regression analysis is based on the required distance that the digital television signal must travel in each transmitting direction in order to provide a good digital television signal to all portions of the desired coverage area. The result of the regression analysis is a plurality of calculated effective radiated power values that the transmission system design can provide in each of the plurality of different transmitting directions. The largest of these values, which corresponds to the worst case transmitting direction, is then compared to the estimated minimum required transmission power calculated previously.

If the calculated effective radiated power for the worst case direction is larger than the estimated minimum required transmission power, this indicates that the design of the digital television transmitting station is sufficient. However, if the calculated effective radiated power for the worst case direction is smaller than the estimated minimum required transmission power, this indicates that the design of the digital television transmitting station may not provide sufficient output power to provide a good digital television signal throughout the desired coverage area. In this instance, one or more design parameters of the digital television transmitting station are altered, and the regression analysis is performed again. The largest of the re-calculated effective radiated power values is then compared to the estimated minimum required transmission power. If the re-calculated power value exceeds the minimum required transmission power, the design can be finalized. If not, the process is repeated.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings, in which like reference numerals refer to like elements, and wherein:

FIG. 1 is a flow chart illustrating a related art method for designing a digital television network;

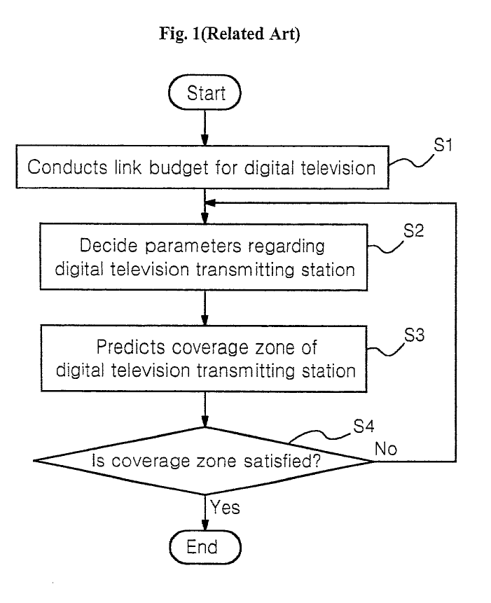

FIG. 2A and FIG. 2B are flow charts illustrating a method for designing a digital television network in accordance with a preferred embodiment of the present invention;

FIG. 3 is a diagram illustrating a radio predictive model for a coverage zone of an analog television transmitting station in accordance with a preferred embodiment of the present invention;

FIG. 4 is an illustration of a window for inputting parameters of a link budget in accordance with a preferred embodiment of the present invention; and

FIG. 5 is an illustration of a window showing a calculated effective radiated power for each of eight radiating directions in accordance with a preferred embodiment of the present invention.

### DETAILED DESCRIPTION OF PREFERRED EMBODIMENTS

Reference will now be made in detail to the preferred embodiments of the present invention, examples of which are illustrated in the accompanying drawings.

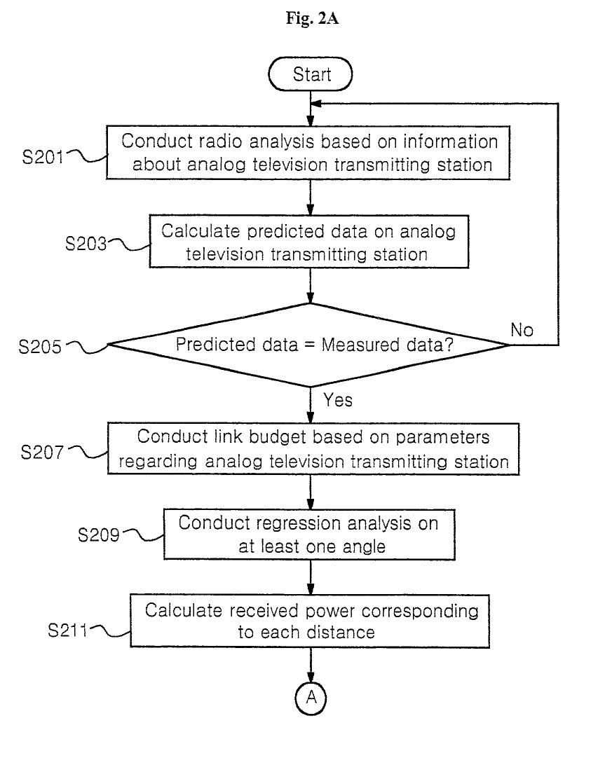

FIGS. 2A and 2B are flow charts illustrating a method for designing a digital television network according to a preferred embodiment of the present invention. According to the present invention, the subject designing method is preferably accomplished by utilizing a wireless network design program.

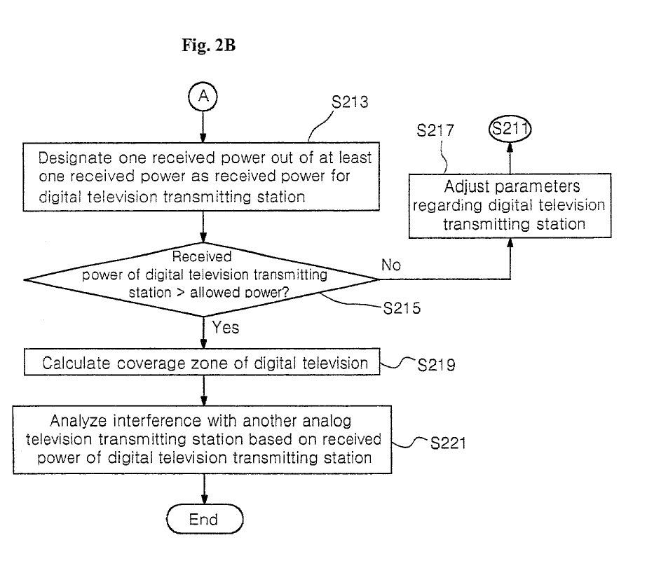

Referring to FIG. 2A, a radio analysis is preferably conducted based on information related to an existing analog television transmitting station (S201). Here, the information on the analog television transmitting station preferably includes information on a transmitting antenna, transmitting power and measured data. Through the radio analysis, predicted coverage for an analog television transmitting station can be calculated (S203). FIG. 3 illustrates the output of a radio predictive model for the analog television transmitting station's coverage zone according to the predicted data.

Data regarding actual transmissions of the analog television transmitting station's coverage may be measured using, for example, a Spectrum Analyzer and a Global Positioning System (GPS) receiver. Measurements are preferably taken when a radio frequency (RF) signal from the analog television transmitting station is transmitted at a constant power.

Once the predicted data is calculated for the analog television transmitting station, the predicted data is compared to the actual measured data to determine whether the predicted data on the analog television transmitting station is in substantial agreement with the aforementioned measured data (S205). If the predicted data for the analog television transmitting station and the measured data are not in substantial agreement, one or more parameters associated with the predicted data are adjusted, and the calculations are performed again, until the predicted data agrees with the measured data.

Once the predicted data on the analog television transmitting station and the measured data are in agreement with each other, a link budget analysis is conducted based on the verified parameters related to the analog television transmitting station (S207). The parameters related to the analog television transmitting station preferably include frequency, dipole factor, thermal noise, antenna gain, cable loss, noise figure, or required carrier/noise ratio. The result of the link budget analysis step is an estimated minimum transmission power required to provide a good digital television signal throughout the desired coverage region.

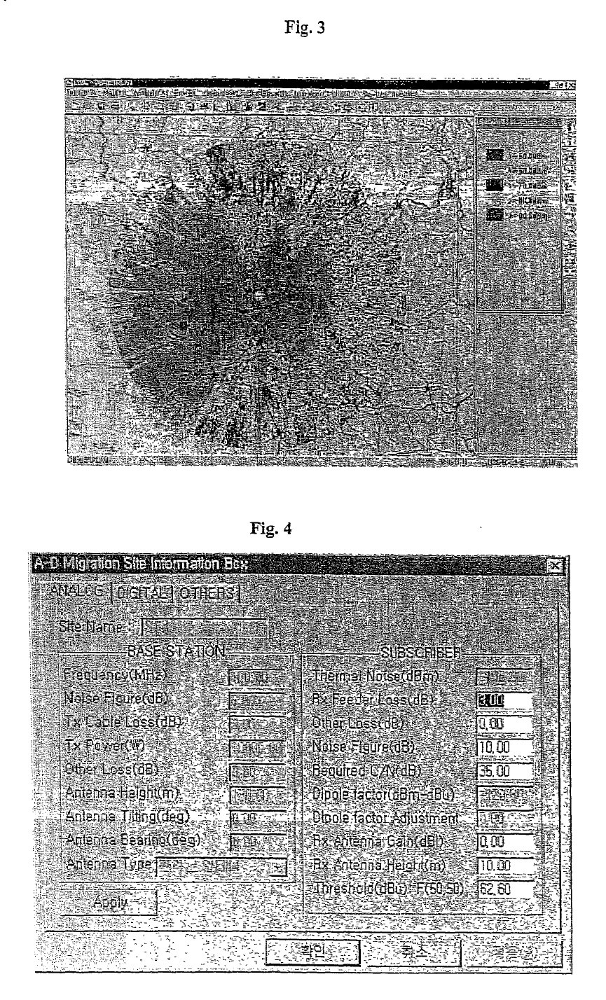

FIG. 4 illustrates a window preferably used to input the parameter(s) of the link budget analysis. The link budget analysis is preferably performed on the basis of the parameters inputted using the input window.

A regression analysis is then conducted for at least one radiating direction to determine the effective radiated power in that direction, given the present design of the digital television transmitting station, and given the distance the signal must travel in that direction. From that analysis, it is possible to calculate a maximum receiving distance corresponding to each radiating direction (S209). Preferably, the regression analysis is performed for a plurality of different radiating directions.

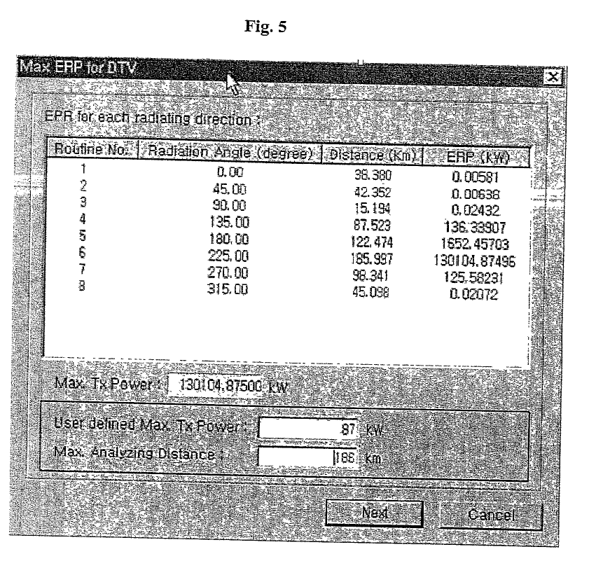

For example, as shown in FIG. 5, if the pre-designated angles include 0 degree, 45 degrees, 90 degrees, 135 degrees, 180 degrees, 225 degrees, 270 degrees, and 15 degrees, the wireless network program calculates a distance for receiving the signal, and the corresponding effective radiated power levels in each of the respective angular directions. In other words, one can use the program to calculate the effective radiated power corresponding to each of the transmission directions. (S211).

One of the effective radiated powers calculated as aforementioned is then selected (S213). The selected value would normally correspond to the worst case direction, which is usually the direction in which the signal must travel the greatest distance. Thus, the maximum power among the multiple effective radiated powers is usually selected.

Preferably, the next step is to compare the selected effective radiated power for the digital television transmitting station from step 213 with the minimum required transmitting power calculated in step 207 (S215). If it turns out that the selected effective radiated power of the digital television transmitting station is more than the minimum required transmitting power, the design of the digital television transmitting station will probably be sufficient to provide a good digital television signal throughout the required coverage area.

However, if the selected effective radiated power of the digital television transmitting station is less than the minimum required transmitting power, the design of the digital television transmitting station may not provide sufficient power to provide a good digital television signal throughout the required coverage area. In this instance, one or more of the parameters for the digital television transmitting station are preferably adjusted (S217). The parameters of the digital television transmitting station that could be adjusted could include antenna gain, antenna kind, antenna height and transmitted power. The regression analysis is then performed again, and the resulting maximum effective radiated power value is again compared to the minimum required transmission power. This process is repeated until the maximum effective radiated power is greater than the minimum required transmission power.

At this point, one can be confident that the design of the digital television transmitting station will be effective. The method proceeds to step 219, where the coverage zone of the digital television is preferably calculated using the chosen parameters (S219).

Once the coverage zone of the digital television is calculated, the wireless network program preferably analyzes an interference with another analog television transmitting station, based on the optimum power for the digital television transmitting station that has been obtained through the comparison carried out in the step 215 (S221). Here, ‘another analog television station’ refers to any analog television transmitting station that provides all broadcasting channels.

The disclosed method for designing a digital television network using existing analog television network information provides many advantages over the prior art. For example, in a preferred embodiment, a resulting digital television network maintains the network figure of the existing analog television and the coverage zone thereof, consequently minimizing the influences and interferences with other existing television networks. In addition, the present invention enables more effective and timely design of a digital television network compared to existing complicated methods that rely exclusively on wireless network design programs. Furthermore, the present invention determines all parameters for the digital television transmitting station, and facilitates design of a relay station that may also be necessary for the digital television network.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for designing a digital television network, comprising:
correcting a radio predictive model based on information related to an existing analog television transmitting station;
conducting a link budget analysis based on parameters regarding the existing analog television transmitting station to determine a minimum required transmitting power;
designating one of a plurality of effective radiated powers calculated by a regression analysis as a effective radiated power for a digital television transmitting station; and
comparing the designated effective radiated power for the digital television transmitting station to the minimum required transmitting power.

2. The method according to claim 1, further comprising calculating a coverage zone of the digital television based on the effective radiated power.

3. The method according to claim 1, wherein the information related to the existing analog transmitting station includes at least one of information regarding an antenna, information regarding an effective radiated power, and actual measured data.

4. The method according to claim 1, further comprising analyzing interference between the digital television transmitting station and an analog television transmitting station.

5. The method according to claim 1, wherein correcting a radio predictive model comprises:
calculating predicted data for the existing analog television transmitting station using a model based on information related to the existing analog television transmitting station;
comparing the calculated predicted data to actual measured data; and
adjusting the model and repeating the calculating and comparing steps until the predicted data and the actual measured data are in agreement.

6. The method according to claim 1, further comprising performing a regression analysis, using a set of digital television transmitting station design parameters, to calculate a plurality of effective radiated powers required to transmit the digital television signal to required maximum distances in a corresponding plurality of different transmitting directions.

7. The method according to claim 6, wherein the designating step comprises selecting the maximum effective radiated power from among the plurality of effective radiated powers.

8. The method according to claim 7, further comprising:
adjusting at least one of the set of digital television transmitting station design parameters if the result of the comparing step indicates that the designated effective radiated power is less than the minimum required transmitting power;
re-calculating a plurality of effective radiated powers required to transmit the digital television signal to required maximum distances in a corresponding plurality of different transmitting directions using the adjusted design parameters;
selecting a maximum effective radiated power from among the plurality of recalculated effective radiated powers;
comparing selected maximum effective radiated power to the minimum required transmitting power; and
repeating the adjusting, re-calculating, selecting, and comparing steps until the selected maximum effective radiated power is greater than the minimum required transmitting power.

9. A method for designing a digital television network, comprising:
calculating predicted data for an existing analog television transmitting station by conducting a radio analysis based on actual measured data for the existing analog television transmitting station;
calculating a minimum required transmission power for a digital television transmitting station by conducting a link budget analysis that is based on parameters regarding the existing analog television transmitting station;
performing a regression analysis, based on design parameters of the digital television transmitting station, to calculate a plurality of effective radiated powers corresponding to different transmitting directions;
selecting one of the plurality of effective radiated powers as an effective radiated power for the digital television transmitting station;
determining whether the selected effective radiated power for the digital television transmitting station is greater than the minimum required transmission power; and
designating the effective radiated power as an optimum power for the digital television transmitting station, if the effective radiated power for the digital television transmitting station is greater than the minimum required transmission power.

10. The method according to claim 9, further comprising calculating a coverage zone of a digital television transmitting station based on the optimum power of the digital television transmitting station.

11. The method according to claim 9, further comprising varying at least one of the design parameters of the digital television transmitting station if the effective radiated transmitting power is less than the minimum required transmission power.

12. The method according to claim 11, further comprising:
performing a new regression analysis, based on the varied design parameters of the digital television transmitting station, to calculate a plurality of new effective radiated powers corresponding to different transmitting directions;
selecting one of the plurality of new effective radiated powers as an effective radiated power for the digital television transmitting station;
determining whether the selected effective radiated power for the digital television transmitting station is greater than the minimum required transmission power;
repeating the varying, performing, selecting and determining steps until the selected effective radiated power is greater than the minimum required transmission power.

13. The method according to claim 9, further comprising analyzing an interference between the digital television transmitting station and a second analog television transmitting station, based on the optimum power for the digital television transmitting station.

14. The method according to claim 9, wherein calculating the predicted data on the first analog television transmitting station comprises:
calculating a coverage zone of the existing analog television transmitting station using predicted data values;
comparing the calculated coverage zone to an actual measured coverage zone of the existing analog television transmitting station; and
varying the predicted data values until the calculated coverage zone substantially agrees with the actual measured coverage zone.

15. A computer readable medium having a set of instruction configured to cause a computer to perform a method for designing a digital television transmitting station, comprising:
correcting a radio predictive model based on information related to an existing analog television transmitting station;
conducting a link budget analysis based on parameters regarding the existing analog television transmitting station to determine a minimum required transmitting power;
designating one of a plurality of effective radiated powers calculated by a regression analysis as a effective radiated power for a digital television transmitting station; and
comparing the designated effective radiated power for the digital television transmitting station to the minimum required transmitting power.

16. The computer readable medium of claim 15, wherein the instructions also cause the computer to calculate a coverage zone of the digital television based on the effective radiated power.

17. The computer readable medium of claim 15, wherein the instructions also cause the computer to analyze interference between the digital television transmitting station and an analog television transmitting station.

18. The computer readable medium of claim 15, wherein the instructions also cause the computer to perform the steps of:
calculating predicted data for the existing analog television transmitting station using a model based on information related to the existing analog television transmitting station;
comparing the calculated predicted data to actual measured data; and
adjusting the model and repeating the calculating and comparing steps until the predicted data and the actual measured data are in agreement.

19. The computer readable medium of claim 15, wherein the instructions also cause the computer to perform a regression analysis, using a set of digital television transmitting station design parameters, to calculate a plurality of effective radiated powers required to transmit the digital television signal to required maximum distances in a corresponding plurality of different transmitting directions.

20. The computer readable medium of claim 15, wherein the instructions also cause the computer to perform the designating step such that the maximum effective radiated power is selected from among the plurality of effective radiated powers.

21. The computer readable medium of claim 15, wherein the instructions also cause the computer to perform the steps of:
adjusting at least one of the set of digital television transmitting station design parameters if the result of the comparing step indicates that the designated effective radiated power is less than the minimum required transmitting power;
re-calculating a plurality of effective radiated powers required to transmit the digital television signal to required maximum distances in a corresponding plurality of different transmitting directions using the adjusted design parameters;
selecting a maximum effective radiated power from among the plurality of recalculated effective radiated powers;
comparing selected maximum effective radiated power to the minimum required transmitting power; and
repeating the adjusting, re-calculating, selecting, and comparing steps until the selected maximum effective radiated power is greater than the minimum required transmitting power.
